(19) United States
(12) Patent Application Publication
(10) Pub. No.: US 2014/0085587 A1
(43) Pub. Date: Mar. 27, 2014

(54) Chip-On-Film Structure for Liquid Crystal Panel

(71) Applicants: Liangchan Liao, Shenzhen (CN); Poshen Lin, Shenzhen (CN); Yong Zhang, Shenzhen (CN)

(72) Inventors: Liangchan Liao, Shenzhen (CN); Poshen Lin, Shenzhen (CN); Yong Zhang, Shenzhen (CN)

(73) Assignee: Shenzhen China Star Optoelectronics Technology Co., Ltd., Guangdong (CN)

(21) Appl. No.: 13/259,201

(22) PCT Filed: Jul. 11, 2011
(86) PCT No.: PCT/CN2011/077023

§ 371 Date: Sep. 23, 2011

(30) Foreign Application Priority Data
Jun. 16, 2011 (CN) 201110161950.9

(51) Int. Cl. G02F 1/1345

(52) U.S. Cl. CPC G02F 1/13452; G02F 1/13454
USPC 349/151

(57) ABSTRACT

The present invention provides a chip-on-film (COF) structure for a liquid crystal panel, which comprises a flexible substrate, a driver chip, a plurality of output-side traces. The flexible substrate is provided with an output edge to be connected to a liquid crystal panel. The driver chip is disposes on the upper surface of the flexible substrate, and the longitudinal direction of the driver chip is perpendicular or oblique to the output edge. The output-side traces are linear, curved or L-shape to connect terminals of two sides of the driver chip to the output edge, so as to simplify the circuit layout of the COF structure.

### FIELD OF THE INVENTION

The present invention relates to a chip-on-film (COF) structure for a liquid crystal panel, and more particularly to a COF structure in which the longitudinal direction of a driver chip is perpendicular or oblique to an output edge.

### BACKGROUND OF THE INVENTION

A liquid crystal display (LCD) is a type of flat panel display (FPD) which displays images by the property of the liquid crystal material. In comparison with other display devices, the LCD has the advantages in lightweight, compactness, low driving voltage and low power consumption, and thus has already become the mainstream product in the whole consumer market. In a traditional process of LCD panel, it comprises a front-end array process, a mid-end cell process and a back-end modulation process. The front-end array process is used to produce thin-film transistor (TFT) substrates (also called array substrates) and color filter (CF) substrates; the mid-end cell process is used to combine the TFT substrate with the CF substrate, then fill liquid crystal into a space therebetween, and cut to form panels with a suitable product size; and the back-end modulation process is used to execute an installation process of the combined panel, a backlight module, a panel driver circuit, an outer frame, etc.

As mentioned above, LCD driver chips are the important components of the LCD, and the main function thereof is to output the needed voltage to pixels, so as to control the twist degree of liquid crystal molecules. There are two types of LCD driver chips: one is the Source driver chip arranged on X-axis, the other is the Gate driver chip arranged on Y-axis. In another word, the Source driver chips control signals of image, and the Gate driver chips control signals of gate switch, so they have different functions for the LCD panel. Simply speaking, images of LCD are formed by scanning lines one by one. The Gate driver chip controls the vertical signals. If the scanning is started from the topmost line, the first pin of the Gate driver chip is set to be switched on, and others are set to be switched off. The signals in the Source driver chip are the real signal (horizontal), and the sent signal is only accepted by horizontal pixels of the first line. After the signal of the first line is transmitted, the second line will be the next one, while the content of the Source driver chip is changed to the second line, and the second pin of the Gate driver chip is switched on, and others is switched off, so that the data is transmitted to the second line.

Furthermore, an assembly of the driver chips of the back-end modulation process is an assembling technology to combine the packaged Source driver chips and the packaged Gate driver chip with the LCD panel. There are various packaging types of the driver chip for LCD, such as quad flat package (QFP), chip on glass (COG), tape automated bonding (TAB), chip on film (COF), etc, wherein the COF structure has flexibility and smaller circuit pitches, so as to become the mainstream technology of the package of driver chips.

Referring now to FIG. 1, a top view of a traditional COF structure assembled on a liquid crystal panel is illustrated in FIG. 1. Specially explaining, for conveniently describing, FIG. 1 is shown in simplification, wherein the number of the traces is simplified, and some of details which are unrelated to the explanation are also omitted. As shown in FIG. 1, an edge of a liquid crystal panel 91 is connected with a COF structure 92, and the COF structure 92 comprises a flexible substrate 921, a driver chip 922, a plurality of output-side traces 923, and a plurality of input-side traces 924. The flexible substrate 921 is provided with an output edge 9211 and an input edge 9212. The output edge 9211 is used to be connected with the liquid crystal panel 91, and the input edge 9212 is another side edge opposite to the output edge 9211 to be connected with a circuit board 93.

In addition, the driver chip 922 is a Source driver chip, and the driver chip 922 is elongated-strip like and disposed on the upper surface of the flexible substrate 921. The longitudinal direction of the driver chip 922 is approximately parallel to the output edge 9211; the output-side traces 923 connects the terminals (not shown) of the two sides of the longitudinal direction of the driver chip 922 to the output edge 9211; the input-side traces 924 connects the terminals of the two sides of the longitudinal direction of the driver chip 922 to the input edge 9212.

Furthermore, the arrow direction of the output-side traces 923 and the input-side traces 924 direct the direction of transmitting signals. The input-side traces 924 is used to transmit the signal of circuit board 93 to the driver chip 922; the output-side traces 923 is used to transmit the signal of the driver chip 922 to the liquid crystal panel 91. Besides, the number of traces of the input-side traces 924 are fewer (such as 136 lines), and the number of traces of the output-side traces 923 are more (such as 1102 lines). Therefore, only a few of the lower terminals of the driver chip 922 are connected with the input-side traces 924, and most of the lower terminals of the driver chip 922 are connected with the output-side traces 923. That is to say, most of the lower terminals of the driver chip 922 need to pass through the output-side traces 923, so as to bypass the driver chip 922, and turn to 180 degree to connect the output edge 9211 (upper edge in the Figure). Hence, the conventional COF structure 92 results the whole design of the circuit layout to become complex.

Referring now to FIG. 2, a top view of another traditional COF structure assembled on a liquid crystal panel is illustrated in FIG. 2. The traditional COF structure 92′ in FIG. 2 is substantially similar to the COF structure 92 in FIG. 1, so as to use similar terms and numerals, but the difference therebetween is that: the COF structure 92′ in FIG. 2 is a COF structure 92′ of Gate driver chip. In comparison with FIG. 1, the driver chip 922′ of the COF structure 92′ is a Gate driver chip, and the COF structure 92′ is only connects to the liquid crystal panel 91 without being connected to the circuit board 93.

In addition, the output-side traces 923 comprise first output-side traces 923a and second output-side traces 923b. The first output-side traces 923a transmit signals of the driver chip 922′ to the liquid crystal panel 91, and the second output-side traces 923b transmit signals of the liquid crystal panel 91 to the driver chip 922′. Therefore, most of all terminals of the driver chip 922′ (not shown) pass through the first output-side traces 923a and the second output-side traces 923b to connect with the output edge 9211, so as to connect with the liquid crystal panel 91. The lower terminals of the driver chip 922 need to pass through the output-side traces 923 (the first output-side traces 923a and the second output-side traces 923b), so as to bypass the driver chip 922′, and turn to 180 degree to connect the output edge 9211 (upper edge in the Figure). Hence, the COF structure 92′ also results the whole design of the circuit layout to become complex.

As a result, it is necessary to provide a COF structure for a liquid crystal panel to solve the problems existing in the conventional technologies.

### SUMMARY OF THE INVENTION

The present invention provides a chip-on-film (COF) structure for a liquid crystal panel, so as to solve the problem existing in the conventional technologies that circuit layout becomes complex.

To achieve the above object, the present invention provides a COF structure for a liquid crystal panel, which comprises:

a flexible substrate provided with an output edge to be connected with a liquid crystal panel;

a driver chip configured to an elongated-strip shape, and disposed on the upper surface of the flexible substrate, wherein the longitudinal direction of the driver chip is perpendicular to the output edge; and

a plurality of output-side traces to connect the terminals of the two sides of the longitudinal direction of the driver chip to the output edge.

To achieve the above object, the present invention further provides a COF structure for a liquid crystal panel, which comprises:

a flexible substrate provided with an output edge to be connected with a liquid crystal panel;

a driver chip configured to an elongated-strip shape, and disposed on the upper surface of the flexible substrate, wherein the longitudinal direction of the driver chip has an oblique angle with respect to the output edge; and

a plurality of output-side traces to connect the terminals of the two sides of the longitudinal direction of the driver chip to the output edge.

To achieve the above object, the present invention further provides a COF structure for a liquid crystal panel, which comprises:

a flexible substrate provided with an output edge to be connected with a liquid crystal panel;

a driver chip configured to an elongated-strip shape, and disposed on the upper surface of the flexible substrate, wherein the longitudinal direction of the driver chip is perpendicular to the output edge or has an oblique angle with respect to the output edge; and

a plurality of output-side traces to connect the terminals of the two sides of the longitudinal direction of the driver chip to the output edge.

In one embodiment of the present invention, each of the output-side traces are linear, curved or L-shape.

In one embodiment of the present invention, the output-side traces comprises: first output-side traces outputting signals of the driver chip to the liquid crystal panel; and second output-side traces inputting signals of the liquid crystal panel to the driver chip.

In one embodiment of the present invention, the COF structure further comprises an input edge, and the input edge is another side edge opposite to the output edge, so as to connect with a circuit board.

In one embodiment of the present invention, the COF structure further comprises a plurality of input-side traces to connect the terminals of the two sides of the longitudinal direction of the driver chip to the input edge, and each of the input-side traces are linear, curved or L-shape.

In one embodiment of the present invention, the oblique angle is between 30 degree and 60 degree.

Hence, the present invention provides a COF structure for a liquid crystal panel in which the longitudinal direction of a driver chip is perpendicular or oblique to an output edge. The a plurality of output-side traces are linear, curved or L-shape, and pass through the terminals of two sides of the driver chip for connecting to the output edge, so as to simplify the circuit layout of the COF structure.

### DESCRIPTION OF THE DRAWINGS

FIG. 1 is a top view of a traditional chip-on-film (COF) structure assembled on a liquid crystal panel;

FIG. 2 is a top view of another traditional COF structure assembled on a liquid crystal panel;

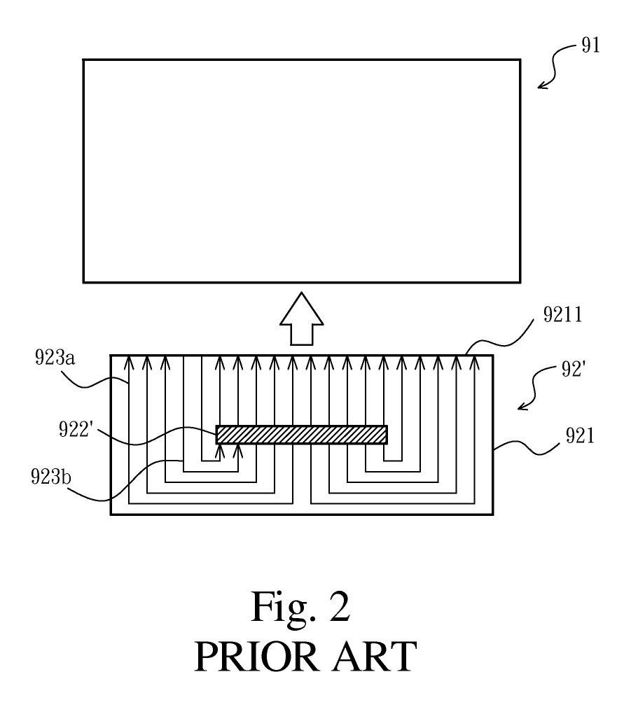

FIG. 3 is a top view of a COF structure assembled on a liquid crystal panel according to a first preferred embodiment of the present invention;

FIG. 4 is a top view of a COF structure assembled on a liquid crystal panel according to a second preferred embodiment of the present invention; and

FIG. 5 is a top view of a COF structure according to a third preferred embodiment of the present invention.

### DETAILED DESCRIPTION OF THE PREFERRED EMBODIMENTS

The foregoing objects, features and advantages adopted by the present invention can be best understood by referring to the following detailed description of the preferred embodiments and the accompanying drawings. Furthermore, the directional terms described in the present invention, such as upper, lower, front, rear, left, right, inner, outer, side and etc., are only directions referring to the accompanying drawings, so that the used directional terms are used to describe and understand the present invention, but the present invention is not limited thereto.

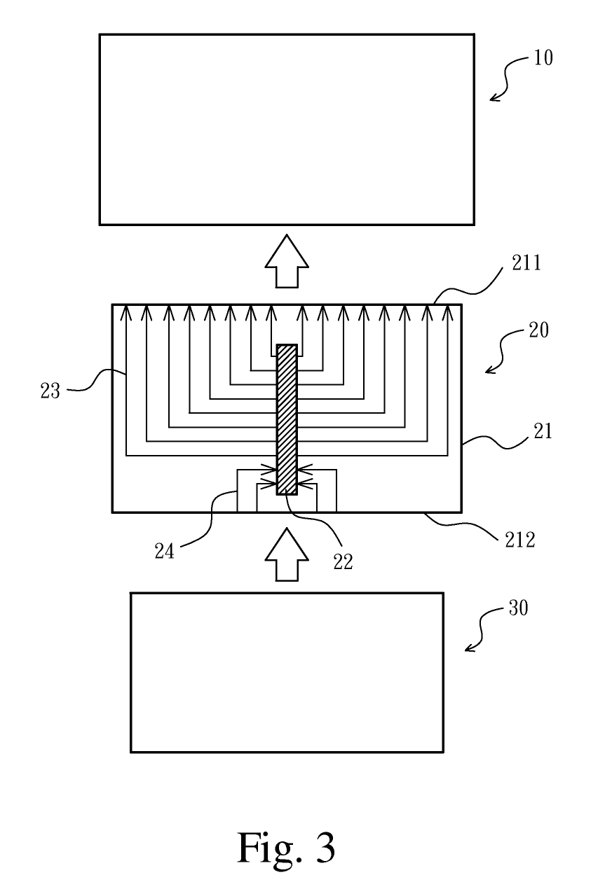

Referring now to FIG. 3, a top view of a chip-on-film (COF) structure assembled on a liquid crystal panel according to a first preferred embodiment of the present invention is illustrated in FIG. 3. Specially explaining, for conveniently describing, FIG. 3 is shown in simplification, wherein the number of the traces is simplified, and some of details which are not unrelated to the explanation are also omitted. As shown in FIG. 3, an edge of a liquid crystal panel 10 is connected with a COF structure 20, and the COF structure 20 comprises a flexible substrate 21, a driver chip 22, a plurality of output-side traces 23, and a plurality of input-side traces 24. The flexible substrate 21 is provided with an output edge 211 and an input edge 212. The output edge 211 is used to be connected with the liquid crystal panel 10, and the input edge 212 is another side edge opposite to the output edge 211, in order to be connected with a circuit board 30.

In addition, the driver chip 22 is a Source driver chip, and the driver chip 22 is elongated-strip like and disposed on the upper surface of the flexible substrate 21, and the longitudinal direction of the driver chip 22 is perpendicular to the output edge 211; the output-side traces 23 are connected to the terminals (not shown) of the two sides of the longitudinal direction of the driver chip 22 and the output edge 211; the input-side traces 24 are connected to the terminals of the two sides of the longitudinal direction of the driver chip 22 and the input edge 212.

Further more, the arrow directions of the output-side traces 23 and the input-side traces 24 represent the direction of the transmitted signals. The input-side traces 24 are used to transmit signals of circuit board 30 to the driver chip 22; the output-side traces 23 are used to transmit signals of the driver chip 22 to the liquid crystal panel 10. Besides, the trace number of the input-side traces 24 are fewer (such as 136 lines), and the trace number of the output-side traces 23 are more (such as 1102 lines). The output-side traces 23 or the input-side traces 24 can be linear, curved or L-shape.

In the conventional COF technologies, because the longitudinal direction (i.e. the length direction) of the driver chip is parallel with the output edge, the lower terminals of the driver chip close to the bottom of figures need to bypass the driver chip and turn to 180 degree to connect the output edge, so that the conventional COF structure results the whole design of the circuit layout to become complex. In the COF structure 20 of the first preferred embodiment of the present invention, because the longitudinal direction of the driver chip 22 is perpendicular to the output edge 211, and the output-side traces 23 or the input-side traces 24 are preferably L-shape, so that it can simplify the circuit layout of the COF structure 20.

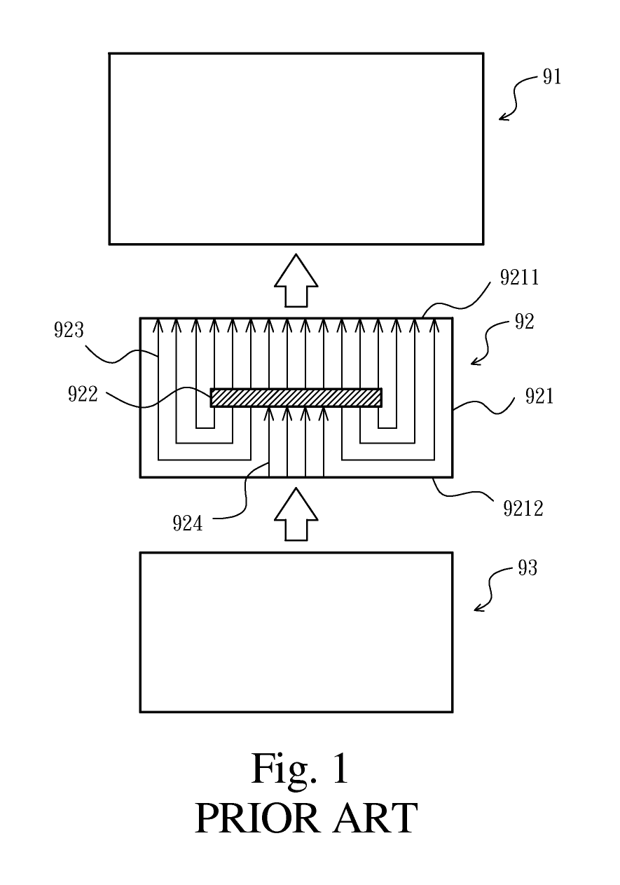

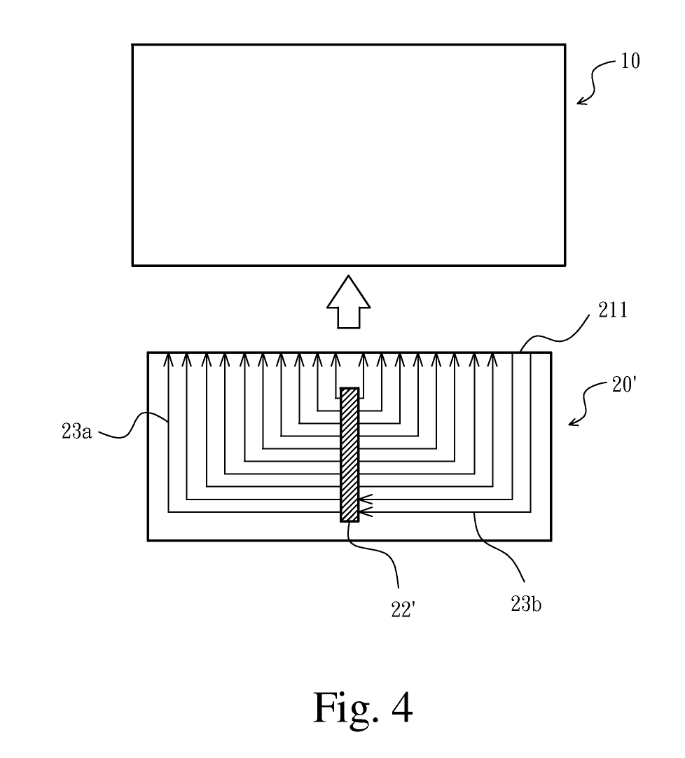

Referring now to FIG. 4, a top view of a COF structure assembled on a liquid crystal panel according to a second preferred embodiment of the present invention is illustrated in FIG. 4. The COF structure 20′ of the second embodiment is similar to the COF structure 20 in the first embodiment, so as to use similar terms and numerals of the foregoing embodiment, but the difference of this embodiment is that: the driver chip 22′ of the COF structures 20′ of the second embodiment is a Gate driver chip. Thus, in comparison with FIG. 1, the driver chip 22′ of the COF structure 20′ of the second embodiment is a Gate driver chip, and the COF structure 20′ is only connected to the liquid crystal panel 10 without being connected to the circuit board 30. In addition, the output-side traces 23 comprise first output-side traces 23a and second output-side traces 23b. The first output-side traces 23a output signals of the driver chip 22′ to the liquid crystal panel 10, and the second output-side traces 23b input signals of the liquid crystal panel 10 to the driver chip 22′. Therefore, most of terminals of the driver chip 22′ (not shown) almost pass through the first output-side traces 23a and the second output-side traces 23b to connect with the output edge 211, so as to then connect with the liquid crystal panel 10.

Because the longitudinal direction of the driver chip 22′ is perpendicular to the output edge 211, and the first output-side traces 23a and the second output-side traces 23b of the output-side traces 23 are preferably L-shape, so that it can simplify the circuit layout of the COF structure 20′.

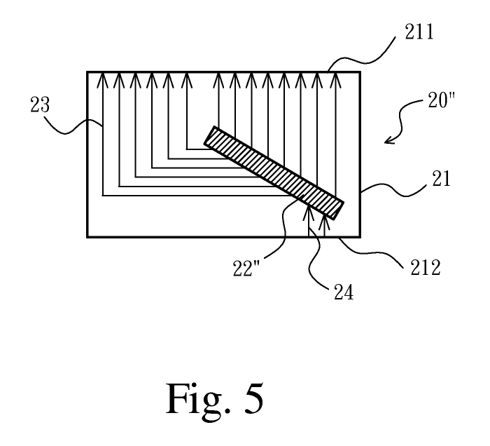

Referring now to FIG. 5, a top view of a COF structure according to a third preferred embodiment of the present invention is illustrated in FIG. 5. The COF structure 20″ of the third embodiment is similar to the COF structure 20 in the first embodiment, so as to use similar terms and numerals of the foregoing embodiment, but the difference of this embodiment is that: the longitudinal direction of the driver chip 22″ has an oblique angle with respect to the output edge 211, and the oblique angle of the driver chip 22″ is preferably between 30 degree and 60 degree. As shown in FIG. 5, the output-side traces 23 close to the upper side of the driver chip 22″ are directly connected with the output edge 211, and the output-side traces 23 close to the lower side of the driver chip 22″ can be curved-shape or L-shape and connected with the output edge 211. Therefore, the COF structure 20″ of the third embodiment of present invention also can simplify the circuit layout of the COF structure 20.

As described above, for the traditional COF structure, the longitudinal direction of the driver chip is parallel with the output edge, and the lower terminals of the driver chip need to bypass the driver chip, and turn to 180 degree to connect with the output edge, so that the conventional COF structure results the whole design of the circuit layout to become complex. In contrast, for the COF structure 20 of the present invention, because the longitudinal direction of the driver chip 22 is perpendicular or oblique to the output edge 211, and the output-side traces 23 are preferably linear, curved or L-shape, so that it can simplify the circuit layout of the COF structure 20.

The present invention has been described with a preferred embodiment thereof and it is understood that many changes and modifications to the described embodiment can be carried out without departing from the scope and the spirit of the invention that is intended to be limited only by the appended claims.

1. A chip-on-film (COF) structure for a liquid crystal panel, characterized in that: the COF structure comprises:
a flexible substrate provided with an output edge to be connected with a liquid crystal panel;
a driver chip configured to an elongated-strip shape, and disposed on an upper surface of the flexible substrate, wherein a longitudinal direction of the driver chip is perpendicular to the output edge or has an oblique angle with respect to the output edge; and
a plurality of output-side traces, each of the output-side traces being linear, curved or L-shape to connect terminals of two sides of the longitudinal direction of the driver chip to the output edge.

2. The COF structure for the liquid crystal panel according to claim 1, characterized in that: the oblique angle is between 30 degree and 60 degree.

3. The COF structure for the liquid crystal panel according to claim 1, characterized in that: the output-side traces comprises:
first output-side traces outputting signals of the driver chip to the liquid crystal panel; and
second output-side traces inputting signals of the liquid crystal panel to the driver chip.

4. The COF structure for the liquid crystal panel according to claim 1, characterized in that: the COF structure further comprises an input edge, and the input edge is another side edge opposite to the output edge, so as to connect with a circuit board.

5. The COF structure for the liquid crystal panel according to claim 4, characterized in that: the COF structure further comprises a plurality of input-side traces to connect the terminals of the two sides of the longitudinal direction of the driver chip to the input edge, and each of the input-side traces are linear, curved or L-shape.

6. A chip-on-film (COF) structure for a liquid crystal panel, characterized in that: the COF structure comprises:
a flexible substrate provided with an output edge to be connected with a liquid crystal panel;
a driver chip configured to an elongated-strip shape, and disposed on an upper surface of the flexible substrate, wherein a longitudinal direction of the driver chip is perpendicular to the output edge; and
a plurality of output-side traces to connect terminals of two sides of the longitudinal direction of the driver chip to the output edge.

7. The COF structure for the liquid crystal panel according to claim 6, characterized in that: each of the output-side traces are linear, curved or L-shape.

8. The COF structure for the liquid crystal panel according to claim 7, characterized in that: the output-side traces comprises:
first output-side traces outputting signals of the driver chip to the liquid crystal panel; and
second output-side traces inputting signals of the liquid crystal panel to the driver chip.

9. The COF structure for the liquid crystal panel according to claim 6, characterized in that: the COF structure further comprises an input edge, and the input edge is another side edge opposite to the output edge, so as to connect with a circuit board.

10. The COF structure for the liquid crystal panel according to claim 9, characterized in that: the COF structure further comprises a plurality of input-side traces to connect the terminals of the two sides of the longitudinal direction of the driver chip to the input edge, and each of the input-side traces are linear, curved or L-shape.

11. A chip-on-film (COF) structure for a liquid crystal panel, characterized in that: the COF structure comprises:
a flexible substrate provided with an output edge to be connected with a liquid crystal panel;
a driver chip configured to an elongated-strip shape, and disposed on an upper surface of the flexible substrate, wherein a longitudinal direction of the driver chip has an oblique angle with respect to the output edge; and
a plurality of output-side traces to connect terminals of two sides of the longitudinal direction of the driver chip to the output edge.

12. The COF structure for the liquid crystal panel according to claim 11, characterized in that: the oblique angle is between 30 degree and 60 degree.

13. The COF structure for the liquid crystal panel according to claim 11, characterized in that: each of the output-side traces are linear, curved or L-shape.

14. The COF structure for the liquid crystal panel according to claim 13, characterized in that: the output-side traces comprises:
first output-side traces outputting signals of the driver chip to the liquid crystal panel; and
second output-side traces inputting signals of the liquid crystal panel to the driver chip.

15. The COF structure for the liquid crystal panel according to claim 11, characterized in that: the COF structure further comprises an input edge, and the input edge is another side edge opposite to the output edge, so as to connect with a circuit board.

16. The COF structure for the liquid crystal panel according to claim 15, characterized in that: the COF structure further comprises a plurality of input-side traces to connect the terminals of the two sides of the longitudinal direction of the driver chip to the input edge, and each of the input-side traces are linear, curved or L-shape.
